(19) United States
(12) Patent Application Publication
(10) Pub. No.: US 2006/0024060 A1
(43) Pub. Date: Feb. 2, 2006

(54) Apparatus and method for optical interconnects on a carrier substrate

(76) Inventors: Weston C. Roth, Portland, OR (US); James D. Jackson, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/902,979

(22) Filed: Jul. 30, 2004

(51) Int. Cl. H04B 10/00

(52) U.S. Cl. 398/118

(57) ABSTRACT

Numerous embodiments are described of an apparatus and method for line-of-sight, optical signal channel propagating in free-space for interconnectivity between semiconductor packages on a carrier substrate. In one embodiment, a first semiconductor package and a second semiconductor package are coupled to the carrier substrate. A free-space, line-of-sight optical signaling channel is formed between a first semiconductor package and a second semiconductor package. An optical emitter on the first semiconductor package propagates an optical signal to an optical detector on the second semiconductor package along the free-space, line-of-sight optical signaling channel.

### TECHNICAL FIELD

Embodiments of the present invention relate to the field of semiconductor packages, and in one particular embodiment, to interconnecting semiconductor packages.

### BACKGROUND

Most electronic systems include electronic (e.g., semiconductor) packages attached to a printed circuit board (PCB). These electronic packages contain one or more microelectronic dies or other circuitry. The packages are plugged into or otherwise electrically attached to sockets. These sockets are electrically attached to the PCB and connect the microelectronic die or electronic circuits in the package to wiring traces on or embedded in the PCB. The wiring traces provide the interconnections between the microelectronic dies or circuitry on the packages

Computing platforms are trending towards higher bus speeds. This is particularly the case for the central processing unit (CPU) and memory controller hub (MCH) components, between which the front side bus (FSB) or front side interface (FSI) transmits at increasing data rates. At very high GHz-range clock rates, computing systems encounter several phenomena that limit bus speed and performance, typically as the direct result of the spatial extent (i.e., physical length) of the bus and PCB manufacturing variations.

PCBs typically use epoxy glass (or FR-4), which have spatial variations in its dielectric constant that can be attributed to variations in resin content and composition, and the periodic glass weave structure. These dielectric variations lead to phase noise and common-mode noise that distorts signals on the bus. In the PCB manufacturing process, spatial variations in the width, thickness, and surface roughness of etched copper (Cu) microstrip and stripline traces lead to variations in nominal trace impedance (Zo) on the order of +/−20-25%. These transmission line variations lead to problems with impedance matching and ringing, which further degrade and distort signals on the bus. Additionally, longer bus lengths have longer latency and therefore longer delay times which slow transmission rates, as well as add more signal attenuation.

### BRIEF DESCRIPTION OF THE DRAWINGS

Embodiments of the present invention are illustrated by way of example, and not limitation, in the figures of the accompanying drawings in which:

FIGS. 1A-1B illustrate one embodiment of a line-of-sight, optical signal channel propagating in free space for interconnectivity between semiconductor packages on a carrier substrate.

FIG. 2 illustrates another embodiment of a line-of-sight, optical signal channel propagating in free space for interconnectivity between semiconductor packages on a carrier substrate.

FIG. 3 illustrates yet another embodiment of a line-of-sight, optical signal channel propagating in free space for interconnectivity between semiconductor packages on a carrier substrate.

FIG. 4 illustrates a block diagram of one method to propagate a line-of-sight, optical signal channel in free space for interconnectivity between semiconductor packages on a carrier substrate.

FIG. 5 illustrates a block diagram of another method to propagate a line-of-sight, optical signal channel in free space for interconnectivity between semiconductor packages on a carrier substrate.

### DETAILED DESCRIPTION

In the following description, numerous specific details are set forth such as examples of specific materials or components in order to provide a thorough understanding of embodiments of the present invention. It will be apparent, however, to one skilled in the art that these specific details need not be employed to practice embodiments of the present invention. In other instances, well known components or methods have not been described in detail in order to avoid unnecessarily obscuring embodiments of the present invention.

The terms “on,” “above,” “below,” “between,” and “adjacent” as used herein refer to a relative position of one element with respect to other elements. As such, a first element disposed on, above or below another element may be directly in contact with the first element or may have one or more intervening elements. Moreover, one element disposed next to or adjacent another element may be directly in contact with the first element or may have one or more intervening elements.

Any reference in the specification to “one embodiment” or “an embodiment” means that a particular feature, structure, or characteristic described in connection with the embodiment is included in at least one embodiment of the claimed subject matter. The appearances of the phrase, “in one embodiment” in various places in the specification are not necessarily all referring to the same embodiment.

Some parts of the description will be presented using terms such as substrate, carrier substrate, Ball Grid Array (BGA) package, printed circuit board (PCB), and so forth. These terms are commonly employed by those skilled in the art to convey the substance of their work to others skilled in the art.

Numerous embodiments are described of an apparatus and method for line-of-sight, optical signal channel propagating in free-space for interconnectivity between semiconductor packages on a carrier substrate. Embodiments of the invention described herein provide several advantages over prior art transmission line signaling channels. An optical signaling channel is immune to the effects of electronic noise and distortion. This produces an overall increase in the signal-to-noise ratio (SNR) enabling faster data rates on the bus. Additionally, the optical channel performance does not rely upon any physical properties of the PCB such as dielectric uniformity, resin content, glass fiber weave, width, thickness and surface roughness of etched Cu traces. This makes the optical channel less susceptible to manufacturing variations. The extremely high-frequency optical signals (300,000 GHz) relative to radio frequency or microwave electronic signals (3-30 GHz) offer an enormous increase in channel bandwidth, which would enable much faster data rates than conventional buses.

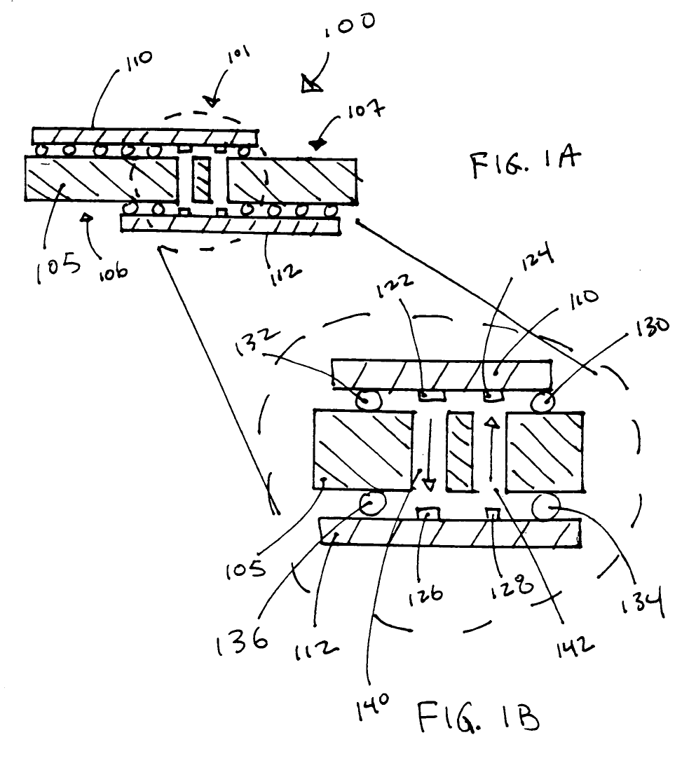

FIG. 1A illustrates a cross sectional view one embodiment of a line-of-sight, optical signal channel propagating in free space for interconnectivity between semiconductor packages on a carrier substrate. System 100 includes a first semiconductor package 110 coupled to a front side 107, and a second semiconductor package 112 coupled to a back side 106 of carrier substrate 105. As illustrated, first semiconductor package 110 and second semiconductor package 112 are coupled with overlapping footprints 101 on opposite sides of carrier substrate 105 (illustrated in greater detail below with respect to FIG. 1B).

In one embodiment, carrier substrate 105 may be a printed circuit board (PCB). Carrier substrate 105 includes an insulating layer made of epoxy glass (not shown). Carrier substrate 105 may also include an electric circuit with various conducting strips or traces that connect to each other based on the particular application. Carrier substrate 105 may be a multi-layer substrate with several insulating layers and conducting layers, with each conducting layer having its own traces. In one embodiment, semiconductor packages 110, 112 may be a Ball Grid Array (BGA) package. The substrate of the BGA package, in one embodiment, may be an organic laminate substrate that uses epoxy resin dielectric materials or bismaleimide triazine (BT) materials, and copper conductors or traces. In another embodiment, the BGA substrate may be a multi-layer ceramic substrate based on aluminum oxide (Al₂O₃). BGA packages are well known in the art; accordingly, a detailed description is not provided herein.

As illustrated in FIG. 1B of the enlarged view of overlapping portion 101, semiconductor packages 110, 112 are coupled to carrier substrate 105 with solder balls (e.g., solder balls 130, 132, 134, and 136). In one embodiment, solder balls 130, 132, 134, and 136 are subject to high temperature, which causes them to melt and a surface tension pulls semiconductor packages 110, 112 into alignment with carrier substrate 105. Surface tension is the attraction that the molecules at the surface of a drop of melted solder have for each other. The attraction the solder molecules have for each other is greater than the attraction the solder molecules have for semiconductor packages 110, 112 so that the solder does not spread. When semiconductor packages 110, 112 are placed over carrier substrate 105, solder balls 130, 132, 134, and 136 rest over pad areas (not shown) disposed on carrier substrate 105.

FIG. 1B also shows an optical emitter 122 and an optical detector 124 disposed on first semiconductor package 110, and an optical detector 126 and an optical emitter 128 disposed on second semiconductor package 112. Optical signaling between first and second semiconductor packages 110, 112 occurs by line-of-sight by through-hole vias 140 and 142, in which optical emitter 122 is aligned with optical detector 126, and optical emitter 128 is aligned with optical detector 124. For example, a first line-of-sight optical signaling channel is formed by via 140 for propagating an optical signal originating from optical emitter 122 disposed on first semiconductor package 110, and directed towards optical detector 126 disposed on second semiconductor package 112 (as designated by the downward arrow). Analogously, a second line-of-sight optical signaling channel is formed by via 142 for propagating an optical signal originating from optical emitter 128 disposed on second semiconductor package 112, and directed towards optical detector 124 disposed on first semiconductor package 110 (as designated by the upward arrow). In one embodiment, vias 140, 142 may be open for free-space (i.e. air) propagation. Alternatively, vias 140, 142 may be filled with a dielectric material to enhance waveguide effects. Additionally, vias 140, 142 may be plated for use as a path for electrical transmission as well as an optical signal channel.

Optical emitters 122, 128 and optical detectors 124, 126 emit (or detect) light when activated and are disposed to propagate an optical signal in a direction substantially normal to a surface of carrier substrate 105 (i.e., through vias 140, 142). In one embodiment, emitters 122, 128 may be a vertical-cavity surface-emitting or sensing laser (VCSEL), a light emitting diode (LED), a photodetector, an optical modulator, or similar optically active device. In one embodiment, the propagated optical signal may have a wavelength that is about 700 nanometers to about 1 millimeter (i.e., from about the visible light to about the infrared region of the electromagnetic spectrum). In an alternative embodiment, the optical signal may have a wavelength corresponding to other regions of the electromagnetic spectrum that produces the lowest signal loss in free space.

In one embodiment of the present invention, small spherical ball lenses (not shown) may be disposed near at the emitters 122, 128 and/or detectors 124, 126 to focus or collimate the optical signal. The line-of-sight optical signaling channels formed by vias 140, 142 provide the advantage of a relatively short optical channel length, and in one embodiment, on the order of about 0.05 to about 0.07 inches. In one particular embodiment, the optical channel length may be about 0.06 inches.

The free-space, line-of-sight optical signaling configuration described above with respect to FIGS. 1A and 1B provides many advantages over conventional line signaling channels. For example, an optical signaling channel is immune to the effects of electronic noise and distortion. This produces an overall increase in the signal-to-noise ratio (SNR) enabling faster data rates on the bus. Additionally the optical channel performance does not rely upon any physical properties of carrier substrate 105 including, dielectric uniformity, resin content, glass fiber weave, width, thickness and surface roughness of etched Cu traces. This makes the optical channel less susceptible to manufacturing variations. The extremely high-frequency optical signals (300,000 GHz) relative to RF or microwave electronic signals (3-30 GHz) offer an enormous increase in channel bandwidth, which would enable much faster data rates than conventional buses. The free-space optical transmission channels formed by vias 140 and 142 also eliminates the need for integrating optical transmission mediums such as fiber optics or waveguides. Fiber optic and waveguides are not standard in manufacturing carrier substrates (e.g., a PCB), which may result in significant additional cost as well as issues with manufacturing, reliability, component placement, and circuit routing.

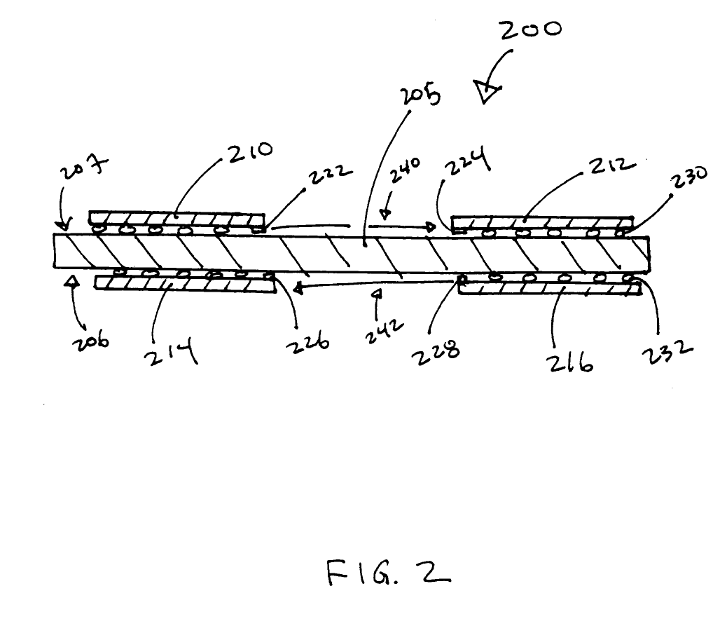

FIG. 2 illustrates another embodiment of a line-of-sight, optical signal channel propagating in free space for interconnectivity between semiconductor packages on a carrier substrate. The configuration of system 200 involves disposing semiconductor packages to both the same and opposite sides of the carrier substrate. As illustrated, system 200 includes a first semiconductor package 210 and a second semiconductor package 212 coupled to a front side 207 of carrier substrate 205. A third semiconductor package 214 and a fourth semiconductor package 216 are coupled to a back side 206 of carrier substrate 205. Semiconductor packages 210, 212, 214, and 216 are coupled to carrier substrate 205 with solder balls (e.g., solder balls 230, 232), and in one embodiment, coupled in a manner similar to that described above with respect to FIGS. 1A-1B. An edge-emitting optical emitter 222 is disposed on first semiconductor package 210, and another edge-emitting optical emitter 228 is disposed on fourth semiconductor package 216. An edge-sensing optical detector 224 is disposed on second semiconductor package 212, and another edge-sensing optical detector 226 is disposed on third semiconductor package 214.

A first free-space, line-of-sight optical channel 240 is formed between first semiconductor package 210 and second semiconductor package 212. A second free-space, line-of-sight optical channel 242 is formed between third semiconductor package 214 and a fourth semiconductor package 216. The direction of optical signal propagation is in a plane substantially parallel to the surface (e.g., top surface 207 and bottom surface 206) of carrier substrate 205. For example, first line-of-sight optical signaling channel 240 may be used to propagate an optical signal originating from optical emitter 222 disposed on first semiconductor package 210, and directed (i.e., aligned) towards optical detector 224 disposed on second semiconductor package 212 (as designated by the right arrow). Analogously, second line-of-sight optical signaling channel 242 may be used to propagate an optical signal originating from optical emitter 228 disposed on fourth semiconductor package 216, and directed towards optical detector 226 disposed on third semiconductor package 214 (as designated by the left arrow).

Optical emitters 222, 228 and optical detectors 224, 226 emit (or detect) light when activated and are disposed to propagate an optical signal in a direction substantially parallel to a surface of carrier substrate 205. In one embodiment, emitters 222, 228 may be a VCSEL, a LED, a photodetector, an optical modulator, or similar optically active device. In one embodiment, the propagated optical signal may have a wavelength that is about 700 nanometers to about 1 millimeter (i.e., from about the visible light to about the infrared region of the electromagnetic spectrum). In an alternative embodiment, the optical signal may have a wavelength corresponding to other regions of the electromagnetic spectrum that produces the lowest signal loss in free space.

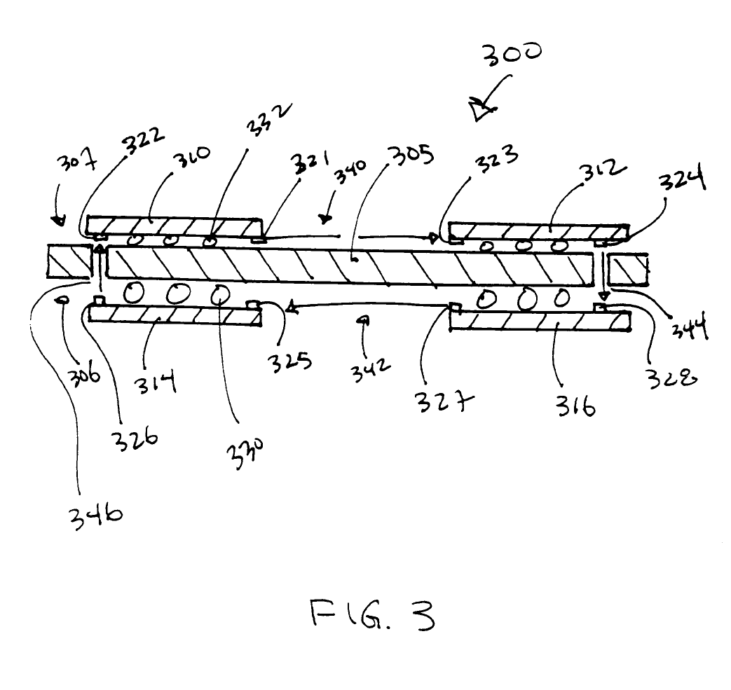

FIG. 3 illustrates yet another embodiment of a line-of-sight, optical signal channel propagating in free space for interconnectivity between semiconductor packages on a carrier substrate. The configuration of system 300 involves propagating optical signals between semiconductor packages disposed to both the same and opposite sides of the carrier substrate. As illustrated, system 300 includes a first semiconductor package 310 and a second semiconductor package 312 coupled to a front side 307 of carrier substrate 305. A third semiconductor package 314 and a fourth semiconductor package 316 are coupled to a back side 306 of carrier substrate 305. Semiconductor packages 310, 312, 314, and 316 are coupled to carrier substrate 305 with solder balls (e.g., solder balls 330, 332), and in one embodiment, coupled in a manner similar to that described above with respect to FIGS. 1A-1B. First semiconductor package 310 has a footprint that overlaps with third semiconductor package 314, and second semiconductor package 312 has a footprint that overlaps with fourth semiconductor package 316. A first via 344 is formed through carrier substrate 305 near the footprint overlap of second semiconductor package 312 and fourth semiconductor package 316, and a second via 346 is formed near the footprint overlap of first semiconductor package 310 and third semiconductor package 314.

An edge-emitting optical emitter 321 is disposed on first semiconductor package 310, and another edge-emitting optical emitter 327 is disposed on fourth semiconductor package 316. An edge-sensing optical detector 323 is disposed on second semiconductor package 312, and another edge-sensing optical detector 325 is disposed on third semiconductor package 314. A first free-space, line-of-sight optical channel 340 is formed between first semiconductor package 310 and a second semiconductor package 312. A second free-space, line-of-sight optical channel 342 is formed between third semiconductor package 314 and a fourth semiconductor package 314. The direction of optical signal propagation for first and second channels 340, 342 is in a plane substantially parallel to the surface (e.g., top surface 307 and bottom surface 306) of carrier substrate 305. For example, first line-of-sight optical signaling channel 340 may be used to propagate an optical signal originating from optical emitter 321 disposed on first semiconductor package 310, and directed (i.e., aligned) towards optical detector 323 disposed on second semiconductor package 312 (as designated by the right arrow). Analogously, second line-of-sight optical signaling channel 342 may be used to propagate an optical signal originating from optical emitter 327 disposed on fourth semiconductor package 316, and directed towards optical detector 325 disposed on third semiconductor package 314 (as designated by the left arrow).

Optical signaling between second and fourth semiconductor packages 312, 316 occurs by line-of-sight by through-hole via 344. Optical signaling between first and third semiconductor packages 310, 314 occurs by line-of-sight by through-hole via 346. For example, a third line-of-sight optical signaling channel is formed by via 344 for propagating an optical signal originating from optical emitter 324 disposed on second semiconductor package 312, and directed (i.e., aligned) towards optical detector 328 disposed on fourth semiconductor package 316 (as designated by the downward arrow). Analogously, a fourth line-of-sight optical signaling channel is formed by via 346 for propagating an optical signal originating from optical emitter 326 disposed on third semiconductor package 314, and directed towards optical detector 322 disposed on first semiconductor package 310 (as designated by the upward arrow). In one embodiment, vias 344, 346 may be open for free-space (i.e. air) propagation. Alternatively, vias 344, 346 may be filled with a dielectric material to enhance waveguide effects. Additionally, vias 344, 346 may be plated for use as a path for electrical transmission as well as an optical signal channel. Optical emitters 324, 326 and optical detectors 322, 328 emit (or detect) light when activated, and are disposed to propagate an optical signal in a direction substantially normal to a surface of carrier substrate 305 (i.e., through vias 344, 346).

In one embodiment, optical emitters 321, 324, 326, 328 may be a VCSEL, LED, a photodetector, an optical modulator, or similar optically active device. In one embodiment, the propagated optical signal may have a wavelength that is about 700 nanometers to about 1 millimeter (i.e., from about the visible light to about the infrared region of the electromagnetic spectrum). In an alternative embodiment, the optical signal may have a wavelength corresponding to other regions of the electromagnetic spectrum that produces the lowest signal loss in free space.

In one embodiment of the present invention, small spherical ball lenses (not shown) may be disposed near at the emitters 324, 326 and/or detectors 322, 328 to focus or collimate the optical signal. The line-of-sight optical signaling channels formed by vias 344, 346 provide the advantage of a relatively short optical channel length, and in one embodiment, on the order of about 0.05 to about 0.07 inches. In one particular embodiment, the optical channel length may be about 0.06 inches.

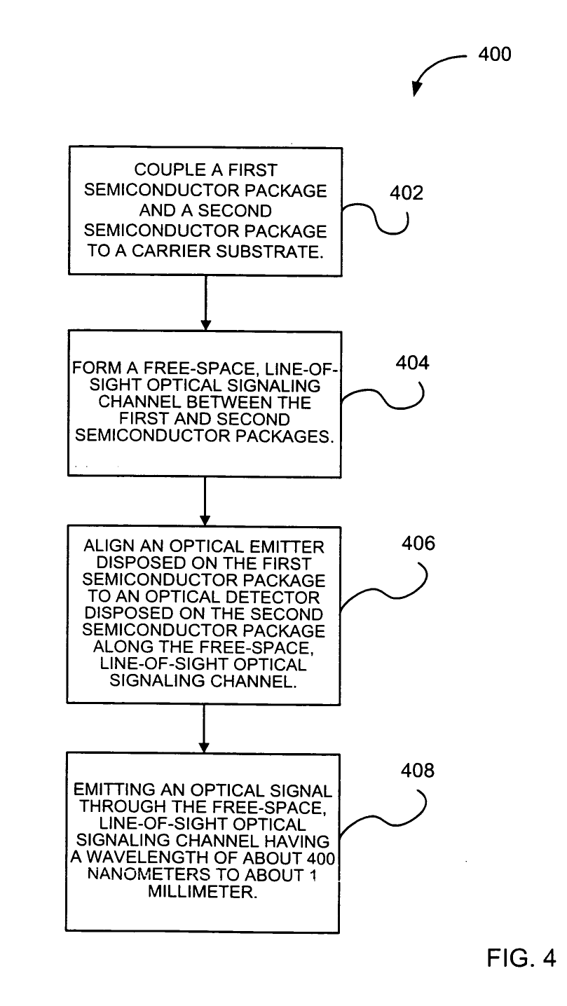

FIG. 4 illustrates a block diagram 400 of one method to propagate a line-of-sight, optical signal channel in free-space between semiconductor packages on a carrier substrate. A first semiconductor package (e.g., package 210) and a second semiconductor package (e.g., package 212) are coupled to a carrier substrate (e.g., carrier substrate 205), block 402. In one embodiment, the semiconductor packages may be BGA packages coupled to a PCB carrier substrate, and may be coupled to a front side and/or a back side of the PCB. A free-space, line-of-sight optical signaling channel (e.g., channel 240) is formed between the first and second semiconductor packages, block 404. In one embodiment the optical signaling channel is formed a plane substantially parallel to a surface or side of the carrier substrate. An optical emitter (e.g., emitter 222) disposed on the first semiconductor package is aligned with an optical detector (e.g., detector 224) disposed on the second semiconductor package along the free-space, line-of-sight optical signaling channel, block 406. An optical signal may then be emitted from the emitter to the detector along the free-space, line-of-sight optical signaling channel. In one embodiment, the optical signal propagated through the signaling channel may have a wavelength of about 400 nanometers to about 1 millimeter, block 408.

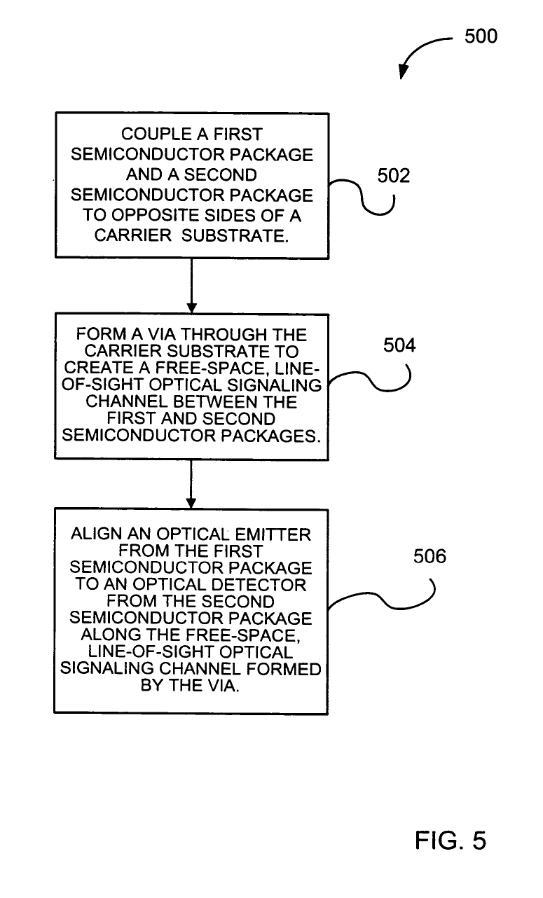

FIG. 5 illustrates a block diagram 500 of another method to propagate a line-of-sight, optical signal channel in free space between semiconductor packages on a carrier substrate. A first semiconductor package (e.g., package 110) and a second semiconductor package (e.g., package 112) are coupled to opposite sides (i.e., to a front side and a back side) of a carrier substrate (e.g., carrier substrate 105), block 502. In one embodiment, the semiconductor packages may be BGA packages coupled to a PCB carrier substrate, and may be coupled to a front side and/or a back side of the PCB. A via (e.g., via 140) is formed through the carrier substrate to create a free-space, line-of-sight optical signaling channel between the first and second semiconductor packages, block 504. In one embodiment the optical signaling channel is formed in a direction substantially normal to a surface of carrier substrate (i.e., through the via).

An optical emitter (e.g., emitter 122) disposed on the first semiconductor package is aligned with an optical detector (e.g., detector 126) disposed on the second semiconductor package along the free-space, line-of-sight optical signaling channel formed by the via, block 506. An optical signal may then be emitted from the emitter to the detector along the free-space, line-of-sight optical signaling channel. In one embodiment, the optical signal propagated through the signaling channel may have a wavelength of about 400 nanometers to about 1 millimeter. In an alternative embodiment, the carrier substrate may have semiconductor packages coupled to both sides for propagating optical signals both along a surface of the carrier substrates, as well as through the carrier substrates using vias (e.g., carrier substrate 305 described above with respect to FIG. 3). The free-space, line-of-sight, optical signal channels eliminate the need for integrating optical transmission mediums such as fiber optics or waveguides into the carrier substrate, while taking advantage of the high speed data transmission capabilities provided by optical signals.

In the foregoing specification, the invention has been described with reference to specific exemplary embodiments thereof. It will, however, be evident that various modifications and changes may be made thereto without departing from the broader spirit and scope of embodiments of the invention as set forth in the appended claims. The specification and figures are, accordingly, to be regarded in an illustrative rather than a restrictive sense.

What is claimed is:

1. An apparatus comprising:
a carrier substrate having a front side and a back side;
a first semiconductor package and a second semiconductor package coupled to the carrier substrate, the first semiconductor package having an optical emitter and the second semiconductor package having an optical detector, wherein a free-space, line-of-sight optical signaling channel is formed between the first semiconductor package and the second semiconductor package.

2. The apparatus of claim 1, wherein the free-space, line-of-sight optical signaling channel is in a plane substantially parallel to the front side of the carrier substrate.

3. The apparatus of claim 1, further comprising a via through the carrier substrate from the front side to the back side, and wherein the free-space, line-of-sight optical signaling channel is formed through the via.

4. The apparatus of claim 1, wherein the carrier substrate comprises a printed circuit board.

5. The apparatus of claim 1, wherein the first and second semiconductor packages comprise a ball grid array.

6. The apparatus of claim 1, wherein the optical emitter and detector comprise a photodiode.

7. The apparatus of claim 1, wherein the optical emitter and detector comprise a vertical cavity surface-emitting or sensing laser.

8. An apparatus comprising:
a carrier substrate having a front side and a back side and a via formed through the front side and the back side;
a first semiconductor package and a second semiconductor package coupled to the front side, and a third semiconductor package coupled to the back side; and
a first free-space, line-of-sight optical signaling channel between the first semiconductor package and the second semiconductor package and a second free-space, line-of-sight optical signaling channel between the second semiconductor package and the third semiconductor package.

9. The apparatus of claim 8, further comprising a first optical emitter disposed on the first semiconductor package aligned with a first optical detector disposed on the second semiconductor package along the first free-space, line-of-sight optical signaling channel.

10. The apparatus of claim 8, further comprising a second optical emitter disposed on the second semiconductor package aligned with a second optical detector disposed on the third semiconductor package along the second free-space, line-of-sight optical signaling channel.

11. The apparatus of claim 10, wherein the second free-space, line-of-sight optical signaling channel is formed through the via.

12. The apparatus of claim 8, wherein the carrier substrate comprises a printed circuit board.

13. The apparatus of claim 8, wherein the first and second semiconductor packages comprise a ball grid array package.

14. A method, comprising:
coupling a first semiconductor package and a second semiconductor package to a carrier substrate having a front side and a back side;
forming a free-space, line-of-sight optical signaling channel between the first and second semiconductor packages; and
aligning an optical emitter disposed on the first semiconductor package with an optical detector disposed on the second semiconductor package along the free-space, line-of-sight optical signaling channel.

15. The method of claim 14, wherein coupling further comprises attaching the first and second semiconductor packages on the front side of the carrier substrate.

16. The method of claim 15, wherein aligning further comprises directing an optical signal in a plane substantially parallel to the front side of the carrier substrate.

17. The method of claim 16, wherein directing further comprises emitting the optical signal having a wavelength of about 400 nanometers to about 1 millimeter.

18. The method of claim 14, wherein coupling further comprises attaching the first semiconductor package on the front side and the second semiconductor package on the back side.

19. The method of claim 18, wherein forming further comprises forming a via through the carrier substrate, the via disposed on a portion of the carrier substrate that is overlapped by the first and second semiconductor packages.

20. The method of claim 19, wherein aligning further comprises directing an optical signal through the via.

21. The method of claim 20, wherein directing further comprises emitting the optical signal having a wavelength of about 400 nanometers to about 1 millimeter.

22. A method, comprising:
coupling a first semiconductor package and a second semiconductor package to a front side of a carrier substrate, and a third semiconductor package to a back side of the carrier substrate;
forming a first free-space, line-of-sight optical signaling channel between the first and second semiconductor packages, and a second free-space, line-of-sight optical signaling channel between the second and third semiconductor packages; and
aligning a first optical emitter disposed on the first semiconductor package with an optical detector disposed on the second semiconductor package along the first free-space, line-of-sight optical signaling channel, and a second optical emitter disposed on the second semiconductor package with an optical detector disposed on the third semiconductor package along the second free-space, line-of-sight optical signaling channel.

23. The method of claim 22, wherein aligning further comprises directing a first optical signal in a plane substantially parallel to the front side of the carrier substrate between the first and second semiconductor packages.

24. The method of claim 23, wherein aligning forming further comprises forming a via through the carrier substrate, the via disposed on a portion of the carrier substrate that is overlapped by the second and third semiconductor packages.

25. The method of claim 24, wherein aligning further comprises directing a second optical signal through the via.

26. The method of claim 23, wherein directing further comprises emitting the first optical signal having a wavelength of about 400 nanometers to about 1 millimeter through the first free-space, line-of-sight optical signaling channel.

27. The method of claim 24, wherein directing further comprises emitting the second optical signal having a wavelength of about 400 nanometers to about 1 millimeter through the second free-space, line-of-sight optical signaling channel.
